(19) United States
(12) Patent Application Publication
(10) Pub. No.: US 2009/0322108 A1
(43) Pub. Date: Dec. 31, 2009

(54) Opposed fork food grasping device

(76) Inventor: Shanaz Bina, Santa Monica, CA (US)

Correspondence Address: Ober, Kaler, Grimes & Shriver;c/o Royal W. Craig, 8th Floor, 120 East Baltimore Street, Baltimore, MD, 21202-1643, US

(21) Appl. No.: 12/215,130

(22) Filed: Jun. 25, 2008

(51) Int. Cl. A47J 43/28; B25B 7/02

(52) U.S. Cl. 294/99.2; 30/322

(57) ABSTRACT

The present invention is a clamshell form eating utensil for gripping and retaining rigid and semi rigid self supporting food items to cleanly and sanitarily bring them to the mouth for eating. The utensil includes an upper and lower leaf pivotally fixed together by a self closing hinge on one edge and formed with a series of times along an opposite edge. The tines include primary gripping tines plus secondary tines providing lateral stability to food items are provided at either end of each leaf. A tail is provided on each leaf extending past the pivotal axis a the hinge operative as a lever to open the utensil, the lower tail bring provided with a plurality of finger holes to aid the diner in manipulating the food during the meal. Drain holes may be provided in each leaf to permit excess sauces and liquids to drain away. A bridging member between the upper and lower leaves protects the hinge from being soiled by food items.

### BACKGROUND OF THE INVENTION

1. Field of the Invention

The present invention relates generally to utensils for eating food and more particularly to such utensils disposed to grasping and holding of food items for consumption thereof.

2. Description of the Background

There have been numerous devices conceived to facilitate clean and sanitary eating of food since human kind first looked for something other than his hands to complete the task. Perhaps the simplest of these is the chopsticks which are generally believed to have originated in China as early as the Shang dynasty (1600-1100 BC) and possibly earlier. Chopsticks are the traditional eating utensils of China, Japan, Korea, Taiwan, and Vietnam and consist of a pair of small even-length tapered sticks between which discrete food items may be grasped and raised to the mouth. The chopstick is also used to direct smaller food items such as rice to the mouth directly from a lifted bowl. Many western cultures find chopsticks difficult to master or use efficiently.

Many Asian cultures incorporate the spoon into modern table settings and the spoon is among the earliest eating utensils of the world. Spoons are thought to have been used as eating utensils since Paleolithic times and likely evolving from a shell or paddle of wood. In the 1st Century A.D. use of the spoon had become considerably more sophisticated as the Romans had several types of spoons for eating various food items. Early spoons were brought to England by the Roman occupation of Britain from A.D. 43 to 410. Modern spoons come in a dizzying variety including soup spoons, tablespoons, teaspoons, dessert spoons, demitasse spoons and grapefruit spoons and many others including the spork, combining the best of the spoon and the fork. As a general matter the spoon is used to scoop and lift liquid, semi-liquid or small solid food items to the mouth.

The first forks were kitchen utensils that appeared in the time of the Greeks. Large, and having two tines, they were used to aid the carving and serving of meat. It wasn't until the 7th Century that royalty of the Middle East began to use forks for dining. First introduced to Western Europe in the 10th century by the Byzantine wife of Emperor Otto II, the table fork had, by the 11th century, made its way to Italy where it became quite popular by the 14th century. Commonly used for eating by merchant and upper classes by 15th century, it was proper for a guest to arrive with his own fork and spoon enclosed in a small box called a cadena. It was not until the 16th century that the fork migrated to Great Britain, although it did not come into common use until early in the 18th century. It was also around this time that the curved, 3 and 4 tined shape of modern forks was developed. The fork was at first used solely to lift food items to the mouth by spearing them with the pointed tines. This use is still common although the modern curved fork is also capable of scooping small food items as well. The spoon and fork were combined in the mid 17th century to produce the spork thereby uniting the functionality of both utensils.

Each of these utensils offers an improvement over eating with the hands although none of them are suitable for eating all foods or all types of foods. In particular, large, self supporting food items such as meat served on the bone, corn served on the cob or even large slices of melon are best eaten by hand as none of the conventional utensils described are useful with these or similar foods. Eating with the hands is, at best, messy and, at worst, unsanitary. What is needed is a utensil capable of universally grasping larger food items to provide a handhold with which they may be brought to the mouth and bitten or otherwise eaten. Such a utensil must be relatively simple to use and inexpensive to manufacture yet must be capable of securely grasping a variety of foods. Such a utensil must also be simple to clean and sanitize and be capable of unlimited reuse. Finally, such an utensil must be acceptable for use in a polite society.

Unfortunately, while each of prior art devices disclosed, i.e. the fork, the spoon and the chopsticks, fulfill their respective, particular roles and objectives in modern dining, they do not present a solution that can universally grasp larger food items to provide a handhold thereto, and there remains a need for such a device.

### SUMMARY OF THE INVENTION

It is, therefore, an object of the present invention to provide a utensil of opposing leaves operative in a clamshell form, each having furcated tines capable of securely gripping and holding a variety of food items from multiple sides or angles.

It is further an object of the present invention to provide a utensil that allows a diner to grasp and consume food items in a clean and sanitary manner.

It is further an object of the present invention to provide a utensil that is shaped to accommodate a wide variety of food shapes and sizes.

It is further an object of the present invention to provide a utensil that can be inexpensively manufactured yet which is capable of unlimited reuse.

It is further an object of the present invention to provide to provide a utensil that may be easily cleaned and sanitized through known automated washing methods.

It is further an object of the present invention to provide a utensil that can be readily incorporated into the dining habits of modern society.

According to the present invention, the above described and other objects are accomplished by an eating utensil, in clamshell form, for gripping food having opposed curved leaves provided with a row or rows of interlocking teeth or tines. The leaves are rotatably connected at their center about a hinge that contains a spring that biases the clamshell in the closed or clamped position such that once a diner has clamped the utensil to a food item it remains securely attached until released by the diner. Each leaf is formed with a tail extending past the hinged connection and operable as a leaver for the diner to open and close the leaves of the utensil to discard a partially eaten food piece and/or grasp a new piece. The tail of the lower leaf is provided with two holes formed in it so that a diner may insert his/her thumb and finger in order to better grasp the utensil.

### BRIEF DESCRIPTION OF THE DRAWINGS

Other objects, features, and advantages of the present invention will become apparent from the following detailed description of the preferred embodiments and certain modifications thereof when taken together with the accompanying drawings in which like numbers represent like items and in which:

FIG. 1 is a three-quarters front perspective view of the utensil.

FIG. 2 is a front elevation view of the utensil.

FIG. 3 is a rear elevation view of the utensil.

FIG. 4 is a side view of the utensil.

FIG. 5 is a three quarters perspective view of an alternate embodiment of the invention.

FIG. 6 is a section view of an alternate embodiment of the invention.

FIG. 7 is a three-quarters front perspective view of the utensil in use.

### DETAILED DESCRIPTION OF THE PREFERRED EMBODIMENT

For the purposes of promoting an understanding of the principles of the invention, reference will now be made to the embodiment illustrated in the drawings, which are described below. The embodiment disclosed below is not intended to be exhaustive or limit the invention to the precise form disclosed in the following detailed description. Rather, the embodiment is chosen and described so that others skilled in the art may utilize its teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

The present invention is an eating utensil that grasps and holds food items between a pair of hingedly opposed leaves or jaws such that a diner may grip the utensil in order to lift the food item to the mouth to bite or otherwise ingest the food without dirtying the hands and without contaminating the food with dirt or other undesirable material on the hands. Importantly, the jaws are spring biased in a closed position such that the diner need only clamp the jaws to the food item when he begins to eat the item, it remaining securely clamped by action of the spring until such time as the item is released.

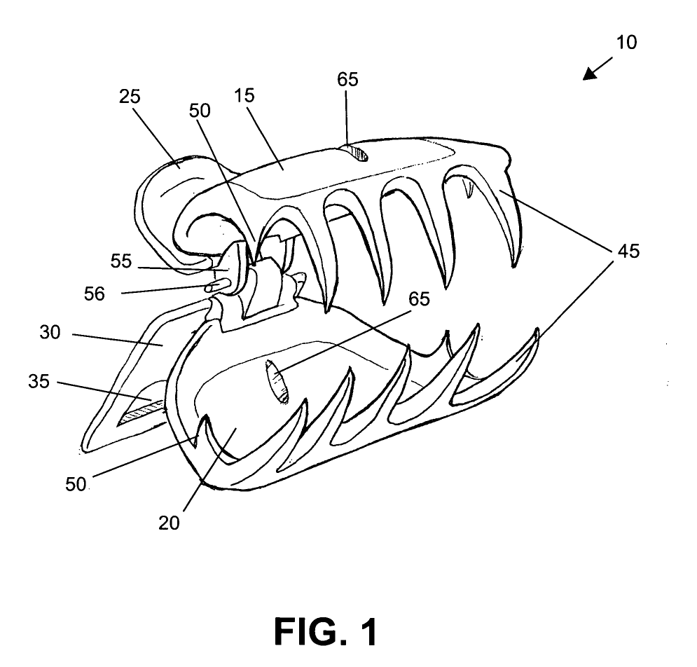

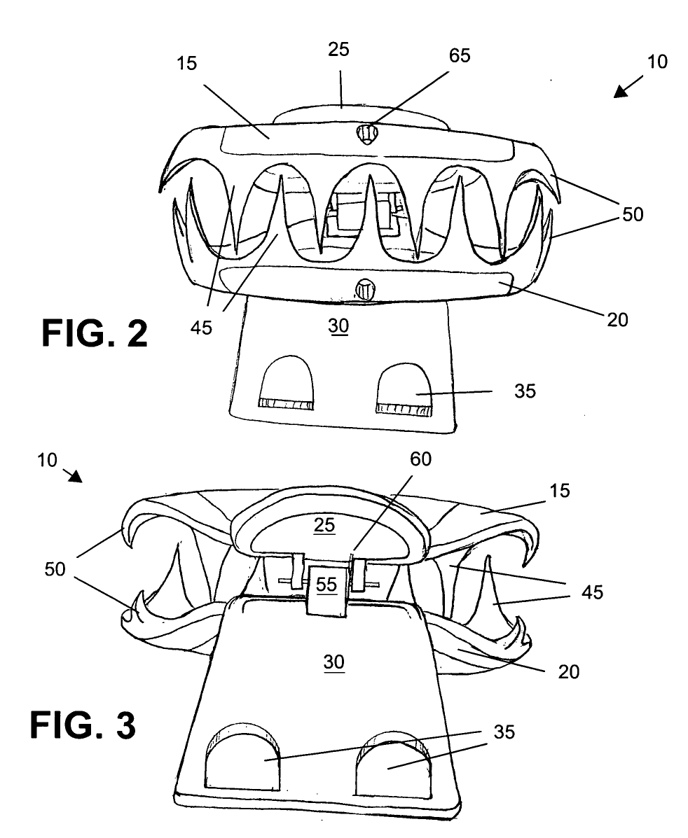

Referring now to FIG. 1 and FIG. 2, the utensil 10 in accordance with the present invention comprises and upper leaf 15 and a lower leaf 20. It should be understood that the terms “upper” and “lower” are relative and are herein used with reference to the figures. It should further be understood that in use the utensil may be manipulated to an infinitely variable orientation while the diner consumes the food clamped within and that the terms “upper” and “lower” are not intended to limit the utensil or reference the relative positions of the two leaves in use.

Upper leaf 15 is formed with a series of furcations or tines 45 along its front edge. Tines 45 are curved slightly inward and are stiff but somewhat flexible along their length so as to conform slightly to the shape of food items placed therein. Tines 45 end, in the illustrated embodiment, in a sharp point capable of piercing and gripping food items. While the illustrated embodiment employs four upper tines 45, there may be any number ranging from two to six or more tines 45 protruding from the upper leaf 15. One or more secondary tines 50 are located on the lateral ends of upper leaf 15 so as to provide lateral stability to food items gripped in the utensil while being manipulated to be eaten.

Lower leaf 20 is similarly formed with a series of furcations or tines 45 along its front edge. Tines 45 are likewise curved slightly inward and are stiff but somewhat flexible along their length ending in sharp point. While the illustrated embodiment employs four lower tines 45, there may be any number ranging from two to six or more tines 45 protruding from the lower leaf 20. Secondary tines 50 are also formed on the lateral ends of lower leaf 20 to provide lateral stability as above. All protruding tines 45 on the lower leaf 20 are offset from tines 45 on the upper leaf so as to interfit when the leaves 15, 20 are closed together.

Upper leaf 15 and lower leaf 20 are pivotally joined at their back edge by hinge 55 to create a clamshell form. Hinge 55 includes torsion spring 60, depicted in FIG. 3, which is biased to maintain the clamshell form of upper leaf 15 and lower leaf 20 in the closed or clamped position about a food item positioned between the leaves. By maintaining the utensil in the closed position the diner may affix the utensil to the desired food item and leave it in position throughout the dining experience relying on the spring tension to retain the grip. This action relieves the diner of the need to continually re-grasp the item, as with chopsticks or tongs, and re-secure the grip each time he wishes to lift or manipulate the food item.

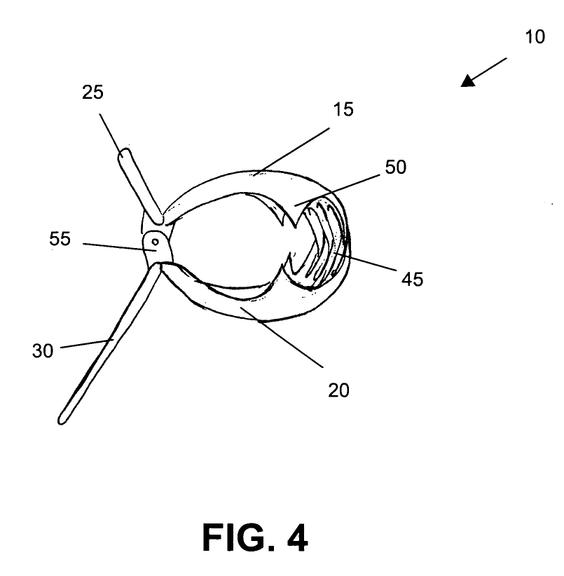

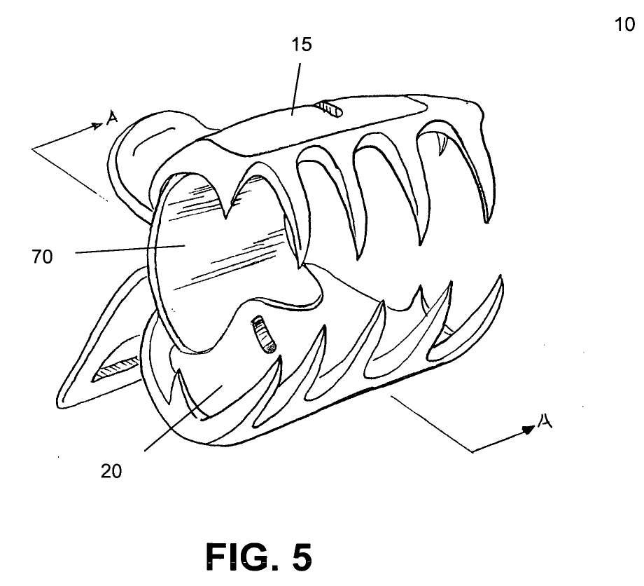

The depicted embodiment of FIGS. 1 and 2 of the present invention includes four (4) upper leaf primary tines 45 and five (5) lower leaf primary tines 45 spaced along the front edge of their respective leaf. The upper and lower tines 45 are positioned such that the tines are received within and meet, but do not surpass the tines of the opposing leaf when the utensil is in the closed position, absent a food item present. This condition is depicted in FIG. 2 and FIG. 4 and permits the utensil to be set on a table or other surface without concern that the possibly soiled tines will extend past the opposing leaf and dirty the surface or surface covering, such as a table cloth, on which it rests. Rotation of hinge 55 about hinge pin 56 (See FIG. 1) toward the close position is limited, absent food within the utensil, by contact of upper and lower tines with the surfaces of the opposing leaf forming the corresponding spaces. It should be understood that the number of upper and lower tines as well as their overall length may be varied with the size of the utensil and yet remain in keeping with the spirit of the invention.

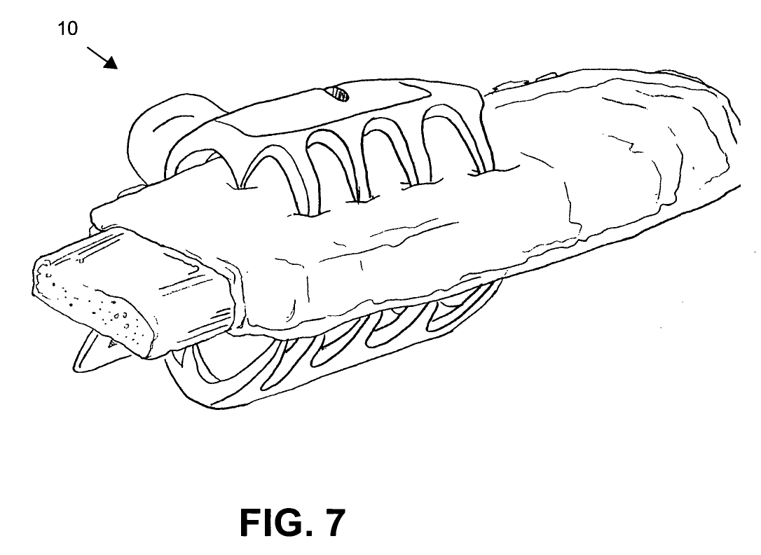

Upper and lower secondary tines 50 are formed such that they do not extend between or receive the secondary tines 50 of the opposing leaf. Rather, secondary tines 50 are shorter than primary tines 45 and engage the surface of food items positioned within the clamshell jaws formed by the uppers and lower leaves, as depicted in FIG. 7. This surface engagement allows the upper and lower leaves to close more fully around linear food items, such as a spare rib, to better grip the item yet still provide lateral support when manipulating such linear food items and prevent such items from slipping through the jaws of the utensil and out the sides.

Upper leaf 15 and lower leaf 20 are further formed with one or more drainage holes 65 in their intermediate surfaces to allow liquids or semi-liquid sauces applied to or otherwise expelled from food items grasped therein to drain from the utensil. Omission of the holes, which may occur in some embodiments of the invention, may allow such sauces and liquids to accumulate within the utensil and subsequently spill or drip on the diner's hands or clothes while dining.

Upper and lower leaves 15, 20, are each formed with a tail to aid in operation of the leaves and grasping of the utensil while in use. With reference to FIGS. 1 and 3, tail 25 of upper leaf 15 extends from the rear edge of leaf 15 over and past hinge 55. Tail 25 acts a leaver in conjunction with tail 30 of lower leaf 20 (described below) to open the jaws formed by the upper and lower leaves 15, 20. Tail 30 of lower leaf 20 similarly extends from the rear edge of leaf 20 under and past hinge 55. Tail 30 similarly acts a leaver in conjunction with tail 25 of upper leaf 15 such that pressing tails 25 and 30 together, as between the thumb and forefingers, with sufficient force to overcome the action of spring 60, will open the clamshell jaws to release food items therein and permit positioning of a new food item. Tail 30 is, in the depicted embodiments, longer than tail 25 and provided with holes 35 so as to serve as a handle for gripping the utensil. Holes 35 permit the diner to insert his fingers/thumb to aid in holding the device and manipulating the food item for consumption.

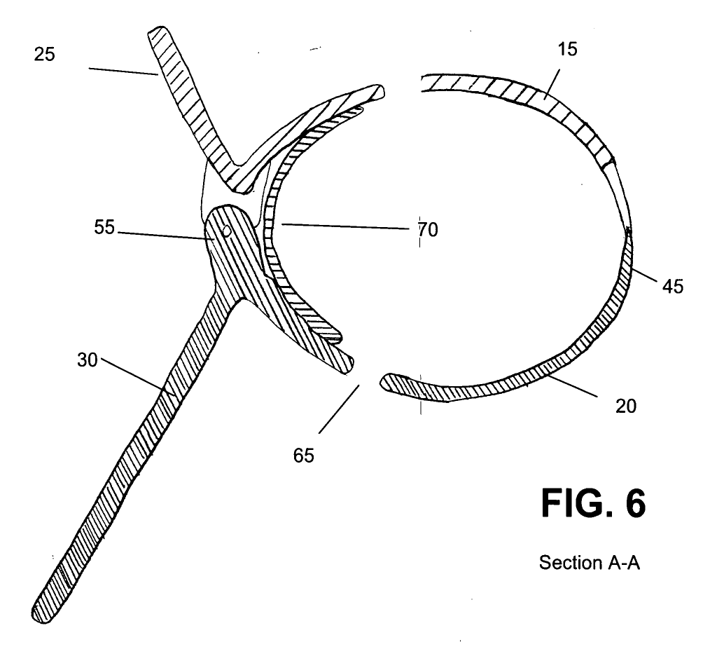

In an alternate embodiment of the present invention, as depicted in FIGS. 5 and 6, a flexible bridging member 70 is provided between upper leaf 15 and lower leaf 20. Bridging member 70 isolates hinge 55 from food items retained in the utensil to prevent soiling of the hinge making it easier to clean the utensil after use. Bridging member 70 is preferably made of a thin film plastic, such as polyethylene or nylon, or a thin metal sheet having elastic bending properties. Bridging member 70, in one embodiment, is affixed to, or may be integrally formed with, one of the leaves 15 or 20 and allowed to slide against the surface of the other leaf so as not to overly impede the rotation of hinge 55 and the closing action of the clamshell form. Nevertheless, it may be necessary to increase the torsional closing force of spring 60 to overcome any opening tendency imparted by bridging member 70 in embodiments incorporating this feature. Where bridging member 70 is affixed to both the upper and lower leaves, the opening tendency imparted by the bridging member 70 may be greater.

Having now fully set forth the preferred embodiment and certain modifications of the concept underlying the present invention, various other embodiments herein shown and described will obviously occur to those skilled in the art upon becoming familiar with said underlying concept. It is to be understood, therefore, that the invention may be practiced otherwise than as specifically set forth in the appended claims.

I claim:

1. A clamshell form eating utensil comprising:
a pair of oppositely disposed leaves, one upper and one lower, each having a front edge, a rear edge, a first end and a second end;
a hinge connected to the rear edge of the upper leaf and said rear edge of the lower leaf and disposed to pivoting about an axis;
a torsion spring in cooperative engagement with said hinge to pivot said leaves about said axis and bias said utensil in the closed position;
a plurality of primary tines periodically spaced along said front edges of said upper leaf and said lower leaf, the tines of each leaf arranged to enter and be received by spaces between the tines of the opposing leaf when the utensil is in the closed position;
a plurality of secondary tines along the first and second ends of the upper leaf and the lower leaf; and
each leaf further comprised of a tail portion extending to the opposite side of said axis from said tines and operative as a lever to open said utensil.

2. The utensil of claim 1 further comprising a flexible bridging member between the upper and lower leaves.

3. The utensil of claim 2 wherein the secondary tines of each leaf are smaller than the primary tines so as not to engage the secondary tines of the opposing leaf when the utensil is in the closed position,

4. The utensil of claim 2 wherein said upper and lower leaves are formed with one or more drainage perforations.

5. The utensil of claim 2 wherein said tail of said lower leaf is formed with a plurality of finger holes.

6. The utensil of claim 1 wherein the secondary tines of each leaf are smaller than the primary tines so as not to engage the secondary tines of the opposing leaf when the utensil is in the closed position,

7. The utensil of claim 1 wherein said upper and lower leaves are formed with one or more drainage perforations.

8. The utensil of claim 1 wherein said tail of said lower leaf is formed with a plurality of finger holes.

9. A clamshell form eating utensil comprising:
a pair of oppositely disposed leaves including one upper leaf and one lower leaf, each of said upper leaf and lower leaf having a front edge, a rear edge, a first end and a second end;
a hinge pivotally connecting the rear edge of the upper leaf and said rear edge of the lower leaf and disposed to pivoting about an axis;
a torsion spring in cooperative engagement with said hinge to pivot said leaves about said axis and bias said utensil toward a closed position;
a first plurality of tines periodically spaced along the front edges of said upper leaf, and a second plurality of tines periodically spaced along the front edges of said lower leaf, the first plurality of tines being laterally offset from the second plurality of tines such that all of said first plurality of tines are received in spaces between the second plurality of tine when said leaves attain said closed position.

10. The clamshell form eating utensil according to claim 9, further comprising a pair of opposing secondary tines positioned at the first and second ends of each of said upper leaf and said lower leaf.

11. The clamshell form eating utensil according to claim 9, wherein each leaf further comprises a tail portion extending to the opposite side of said axis from said tines and operative as a lever to open said utensil.

12. The clamshell form eating utensil of claim 9 further comprising a flexible bridging member between the upper and lower leaves.

13. The clamshell form eating utensil of claim 10 wherein the secondary tines of each leaf are smaller than the primary tines so as not to engage the secondary tines of the opposing leaf when the utensil is in the closed position,

14. The clamshell form eating utensil of claim 9 wherein said upper and lower leaves are formed with one or more drainage perforations.

15. The clamshell form eating utensil of claim 9 wherein said tail of said lower leaf is formed with a plurality of finger holes.
